(19) United States
(12) Patent Application Publication
(10) Pub. No.: US 2016/0345639 A1
(43) Pub. Date: Dec. 1, 2016

(54) DECORATED BLANKET AND METHOD OF USE

(71) Applicants: Paola Mercedes MOORE, Bethlehem, PA (US); Brian Joseph MOORE, Bethlehem, PA (US)

(72) Inventors: Paola Mercedes MOORE, Bethlehem, PA (US); Brian Joseph MOORE, Bethlehem, PA (US)

(21) Appl. No.: 14/997,621

(22) Filed: Jan. 18, 2016

Related U.S. Application Data
(60) Provisional application No. 62/168,361, filed on May 29, 2015.

(51) Int. Cl. A41D 3/00; A41D 11/00; G09B 19/00

(52) U.S. Cl. CPC A41D 3/00; G09B 19/00; A41D 11/00

(57) ABSTRACT

This disclosure teaches a method of conditioning a human to sleep, having the steps of determining, that it is time for said human to take a nap; donning, by said human, a decorated blanket which is a costume for a character in a story where the decorated blanket has a sleeve with an inner surface and an outer surface where at least one piece of fabric, shaped to resemble a caudal fin, is attached and a shimmering mechanism which at least a portion of the outer surface of the sleeve or the piece of fabric; then encouraging this human to imagine that they are a character in a story because the human is wearing the costume; then conveying, to this human a story; and finally repeating, these steps until the human associates the story and decorated blanket with sleep.

### CLAIM OF PRIORITY

This application claims the priority of U.S. Ser. No. 62/168,361 filed on May 29, 2015, the contents of which are fully incorporated herein by reference.

### FIELD OF THE EMBODIMENTS

The invention and its embodiments relate to a decorated blanket and its method of use, in particular a blanket decorated to resemble the tail of a mermaid.

### BACKGROUND OF THE EMBODIMENTS

In today's world, Americans grow more and more sleep deprived with each passing year. One cause of this wide-spread sleep deprivation is the inability of children past a certain age to nap consistently. During the first few years of a child's life, they will take consistent naps without much external influence. However, upon becoming a toddler, many children forego their naps to pursue other inclinations.

While these children might not want to take naps, the National Institutes of Health has conducted a multitude of studies that showing a wide array of beneficial effects from getting a proper amount of sleep. Such benefits include significant boosts in one's immune function, memory, and other physical and cognitive aspects. Specifically, researchers at the NIH have shown that the benefits of naps are even greater for those who regularly indulge, and conclude that consistent napping would be beneficial to children across the nation.

That said, for many children who have fallen out of the habit of napping, a concerted effort is frequently required to get them back into the habit of napping. To this end, an adequate sleep environment that can be reproduced is important, so that a routine may be established to re-manifest the habit of napping in the child.

An ancient, yet still popular technique for encouraging sleep in children is known as “swaddling.” Definitionally, swaddling is the act of wrapping someone in a garment or cloth. Historically, swaddling has been an important part of child-rearing, where it has been used as a sleep aid for children as early as the Paleolithic era and has famously been mentioned regarding the birth of Jesus Christ in the text of the New Testament. While swaddling fell out of favor in the 17^{th} century, the practice has recently made a resurgence in modern society.

Typically swaddling involved binding a user tightly in wraps, however, such tight wrapping is not essential to the process. In fact, engaging in too tight of a swaddle has been potentially linked to Sudden Infant Death Syndrome and developmental hip dysplasia. Further, a tight swaddle is not always needed to assist a child in falling asleep. This is particularly true of children who are no longer in their infancy. For this reason, an appropriately-tight swaddling tool can be highly beneficial in the nap-retraining process.

Review of related technology:

U.S. Pat. No. 1,074,389 pertains to a lap robe intended to warm a user, particularly when said user is located on a ship.

U.S. Patent Publication No.: 2011/0250818 pertains to a mermaid costume which includes a body portion configured to receive the feet and both legs of a user and conform substantially to the body of the user. The mermaid costume may also include a tail portion connected to the body portion. The tail portion together with the body portion provides the user with the appearance of a mermaid. An opening is formed in the body portion to enable two modes for wearing the costume.

U.S. Design Pat. No. D252,308 pertains to an ornamental sleeping bag that resembles a shark. When in use, a user's head is located at the opening of the “mouth” of the shark.

Various devices are known in the art. However, their structure and means of operation are substantially different from the present invention. Such devices fail to provide a device that is optimized for non-infant children, fail to enhance the child's imagination, which is capable of being used as a nap retraining device. At least one embodiment of this invention is presented in the drawings below, and will be described in more detail herein.

### SUMMARY OF THE EMBODIMENTS

The present invention provides for a decorated blanket, comprising a sleeve having an inner surface and an outer surface; said sleeve having attached thereto at least one piece of fabric shaped to resemble a caudal fin; and a shimmering mechanism covering at least a portion of said outer surface of the sleeve or said piece of fabric.

In some embodiments, the device of the present invention is constructed out of a jersey knit fabric, while in other devices the present invention is constructed out of terrycloth. While these two fabrics are utilized in the preferred embodiments, all conventional fabrics are suitable for use with the present invention.

In a preferred embodiment, the decorated blanket of the present invention is sized to snugly envelop the hips and legs of a user. In yet another preferred embodiment, a shimmering mechanism is employed to give the blanket a look of a mermaid's tail. This shimmering mechanism may employ sequins, glitter, rhinestones, beads, studs, and other similar embellishments.

The present invention also contemplates a method of helping a human get to sleep, comprising the steps of determining, that it is time for said human to take a nap; donning, by said human, a decorated blanket which is a costume for a character in a story where the decorated blanket, comprises: a sleeve having an inner surface and an outer surface; said sleeve having attached thereto at least one piece of fabric shaped to resemble a caudal fin; and a shimmering mechanism covering at least a portion of said outer surface of the sleeve or said piece of fabric; encouraging, said human to imagine that said human is a character in a story because the human is wearing the costume; conveying, to said human, said story; and repeating, the above steps until said human associates said story and said decorated blanket with sleep.

It is an object of the present invention to provide a means for retraining a child to nap.

It is an object of the present invention to provide a decorated blanket that resembles a mermaid tail.

It is an object of the present invention to enhance the imagination of children.

It is an object of the present invention to increase the amount of sleep children receive.

It is an object of the present invention to provide a comfortable blanket.

It is an object of the present invention to provide a blanket that is capable of swaddling a human.

### BRIEF DESCRIPTION OF THE DRAWINGS

FIG. 1 shows a front perspective view of an embodiment of the decorated blanket of the present invention.

FIG. 2 shows a top view of an embodiment of the decorated blanket of the present invention.

FIG. 3 shows a bottom view of an embodiment of the decorated blanket of the present invention.

FIG. 4 shows a right side view of an embodiment of the decorated blanket of the present invention.

FIG. 5 shows a front view of an embodiment of the decorated blanket of the present invention.

FIG. 6 shows a rear view of an embodiment of the decorated blanket of the present invention.

FIG. 7 shows a front perspective view of an alternative embodiment of the decorated blanket of the present invention.

FIG. 8 shows a top view of an alternative embodiment of the decorated blanket of the present invention.

FIG. 9 shows a bottom view of an alternative embodiment of the decorated blanket of the present invention.

FIG. 10 shows a right side view of an alternative embodiment of the decorated blanket of the present invention.

FIG. 11 shows a front view of an alternative embodiment of the decorated blanket of the present invention.

FIG. 12 shows a rear view of an alternative embodiment of the decorated blanket of the present invention.

FIG. 13 shows a flow chart of an embodiment of the method of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

While this disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

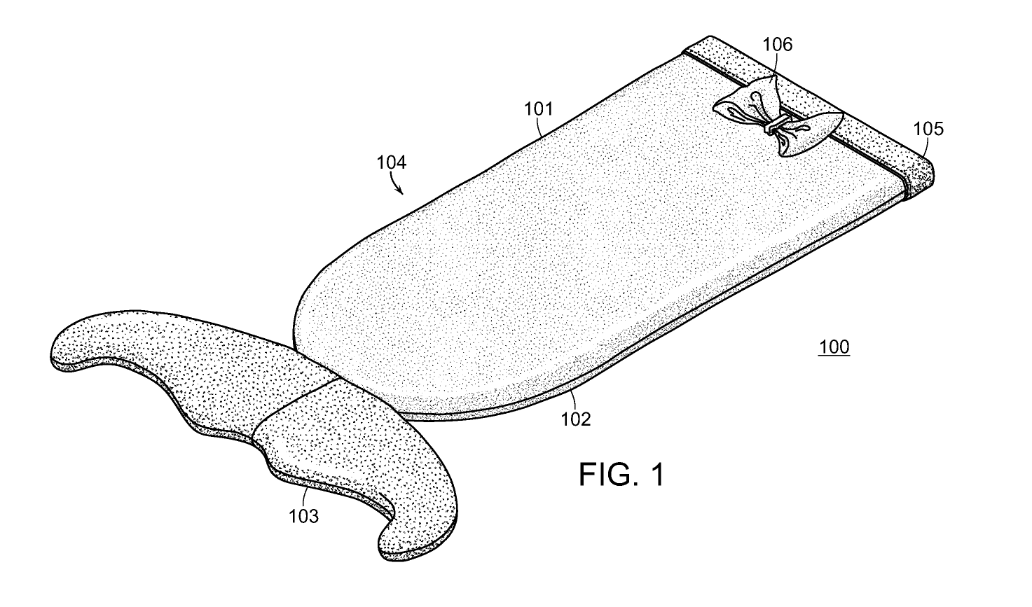

Referring to FIG. 1, a front perspective view of an embodiment of the decorated blanket of the present invention is provided for. Shown in this view is an embodiment of decorative blanket 100. Of note are sleeve 101, outer surface of sleeve 102, at least one piece of fabric 103, shimmering mechanism 104, elastic band 105, and bow 106. In yet another preferred embodiment, at least one piece of fabric 103 has at least two layers and is has foam or padding disposed between said layers. In another embodiment, elastic band 105 is replaced with a drawstring. In yet another embodiment, elastic band 105 is used in conjunction with a drawstring.

In many alternative embodiments, elastic band 105 and bow 106 are optional. In other embodiments, sleeve 101 has outer surface 102 as well as an inner surface (not pictured). In many embodiments, inner surface and outer surface 102 are comprised of different materials. As a non-limiting example, inner surface may be constructed out of a material that is pleasing to a user, such as silk, velvet, or velour, while outer surface 102 is constructed out of a durable material such as cotton, polyester. The present invention can be constructed out of any conventional fabric, however, in a preferred embodiment, the present invention is constructed out of terrycloth. In another preferred embodiment, the present invention is constructed out of jersey-knit fabric. It should be noted that when the present invention is constructed out of terrycloth, decorated blanket 100 may serve as a towel for the user, making it particularly suitable for use after a user washes.

In many preferred embodiments, sleeve 101 is tapered where it attaches to at least one piece of fabric 103. This tapering increases the similarity in appearance of that with a mermaid's tail, allowing a user to more easily imagine themselves as a mermaid or some other character in a story. Second, the tapering allows decorated blanket 100 to better conform to a user's body. The more tightly that decorated blanket 100 conforms to a user's body, the more effective decorated blanket 100 is at swaddling this user.

In various embodiments, the decorative blanket of the present invention is sized to cover different portions of a human user. In one embodiment, decorated blanket 100 merely covers the legs of a user. In another embodiment, decorated blanket 100 covers both the legs and the hips of a human user. In yet another embodiment, decorated blanket 100 covers the legs, hips, and midriff of a human user. In another embodiment, decorated blanket 100 is covers the entirety of a user. Further, shimmering mechanism 104 may employ a number of techniques. For example, glitter, sequins, beads, gems, rhinestones, and acrylic jewels are all suitable for use in shimmering mechanism 104. In many preferred embodiments, shimmering mechanism 104 is employed such that decorated blanket 100 resembles a mermaids tail, or some other type of aquatic creatures tail, such as a fish or a dolphin.

Moreover, in many alternative embodiments of the present invention; decorated blanket 100 is equipped with an expansion mechanism. Preferably, this mechanism will be located along the side of sleeve 100, near optional elastic band 105. This mechanism can employ zippers, hook and loop fasteners, magnets, and/or buttons, for example. In many embodiments, the opening of sleeve 101 can be expanded while a human user enters decorative blanket 100, and after the user has inserted themselves into sleeve 101, the expansion mechanism may then be closed such that sleeve 101 is once again capable of swaddling a human user.

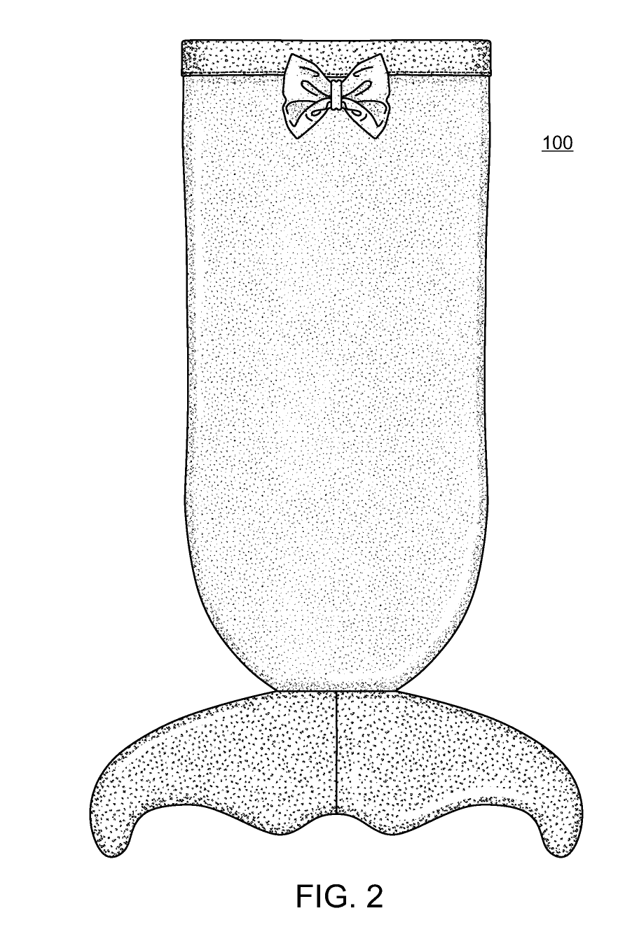

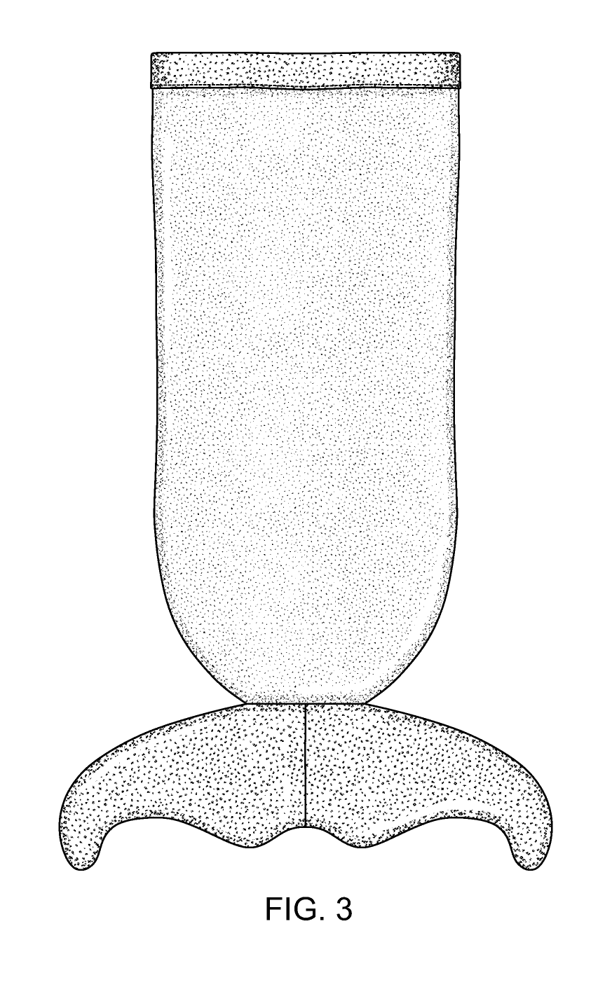

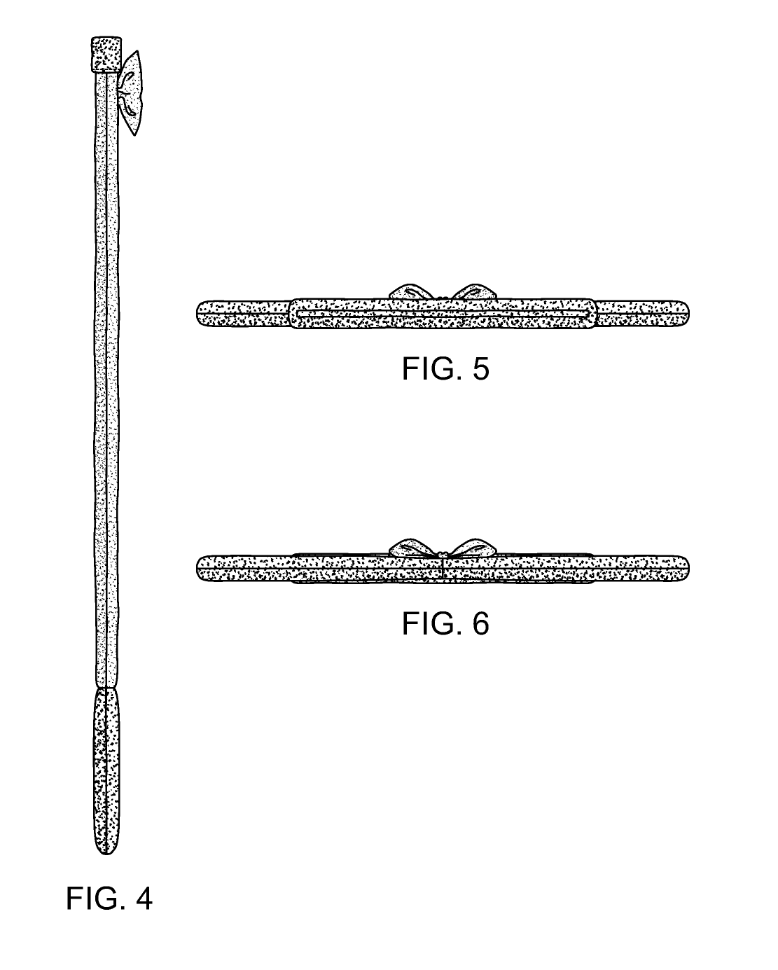

FIGS. 2-6 show alternative views of the embodiment of the decorated blanket of the present invention depicted in FIG. 1, providing for a full disclosure of the structural components of a preferred embodiment of the decorated blanket of the present invention.

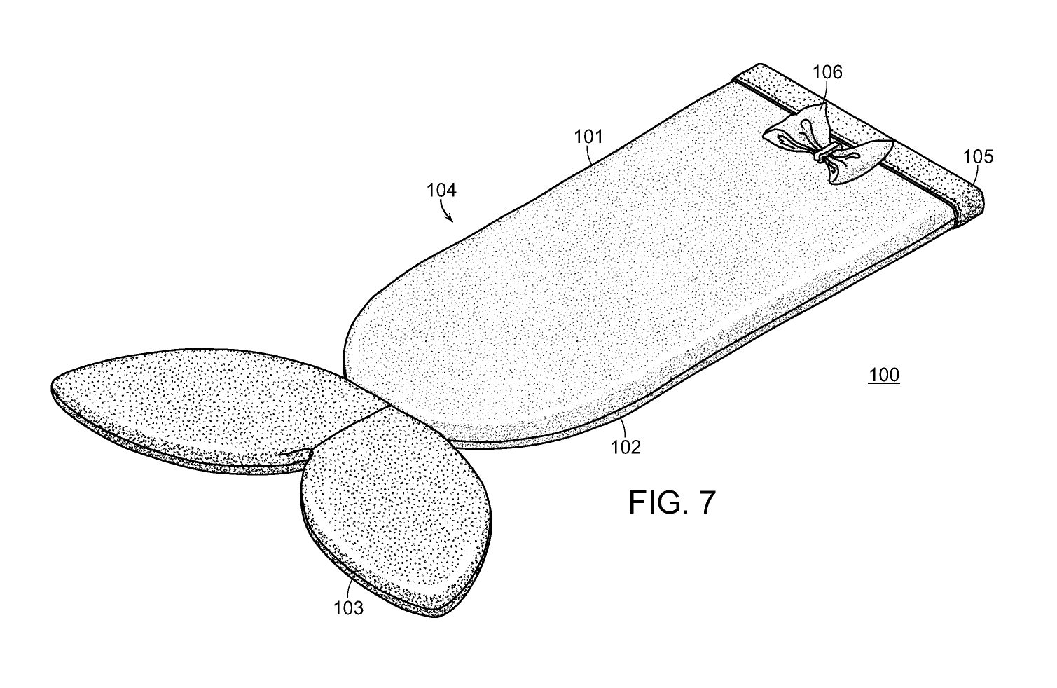

FIG. 7 shows a front perspective view of an alternative embodiment of the decorated blanket of the present invention. Like the embodiment of the decorated blanket presented in FIG. 1, this embodiment of decorated blanket 100 comprises sleeve 101, outer surface 102, at least one piece of fabric 103, shimmering mechanism 104, elastic band 105 and bow 106. Of note here is the different composition of at least one piece of fabric 103. Here, at least one piece of fabric 103 resembles a caudal fin, however, it is a different variant than that of the embodiment shown in FIG. 1. It should be noted that at least on piece of fabric may resemble a caudal fin, where said caudal fin can be, but is not limited to a round caudal fin, a forked caudal fin, an indented caudal fin, a truncated caudal fin, a lunate caudal fin, a dual-split caudal fin, and a pointed caudal fin.

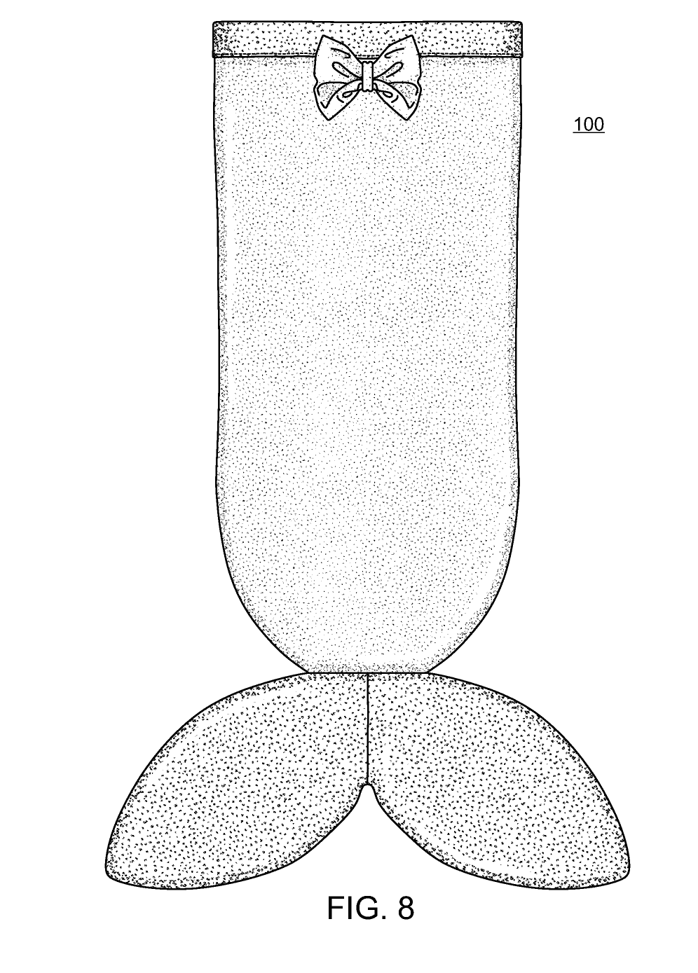

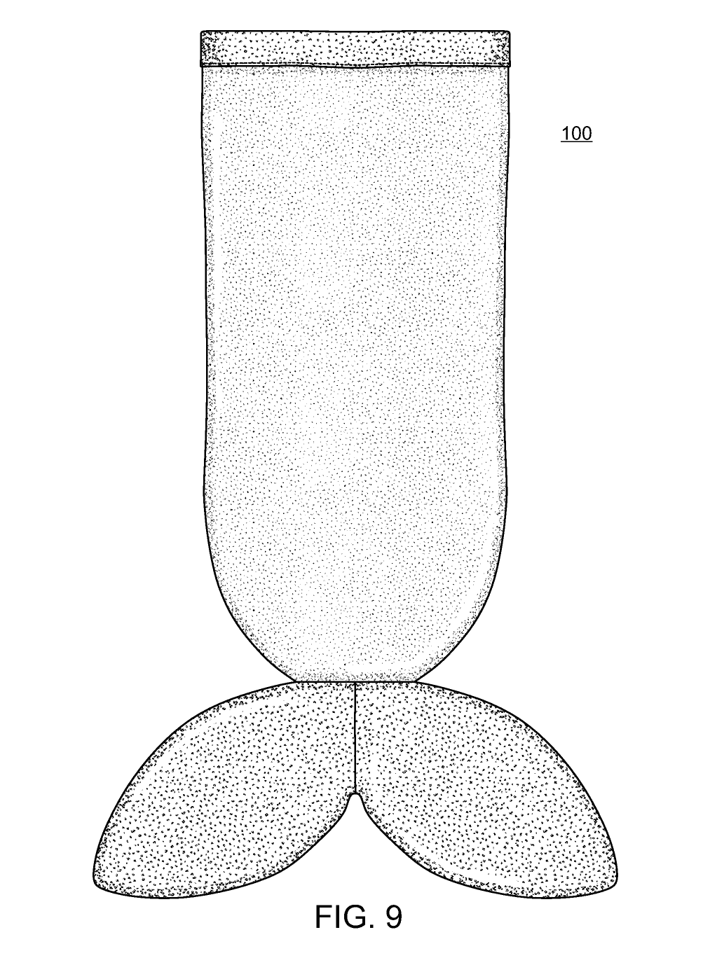

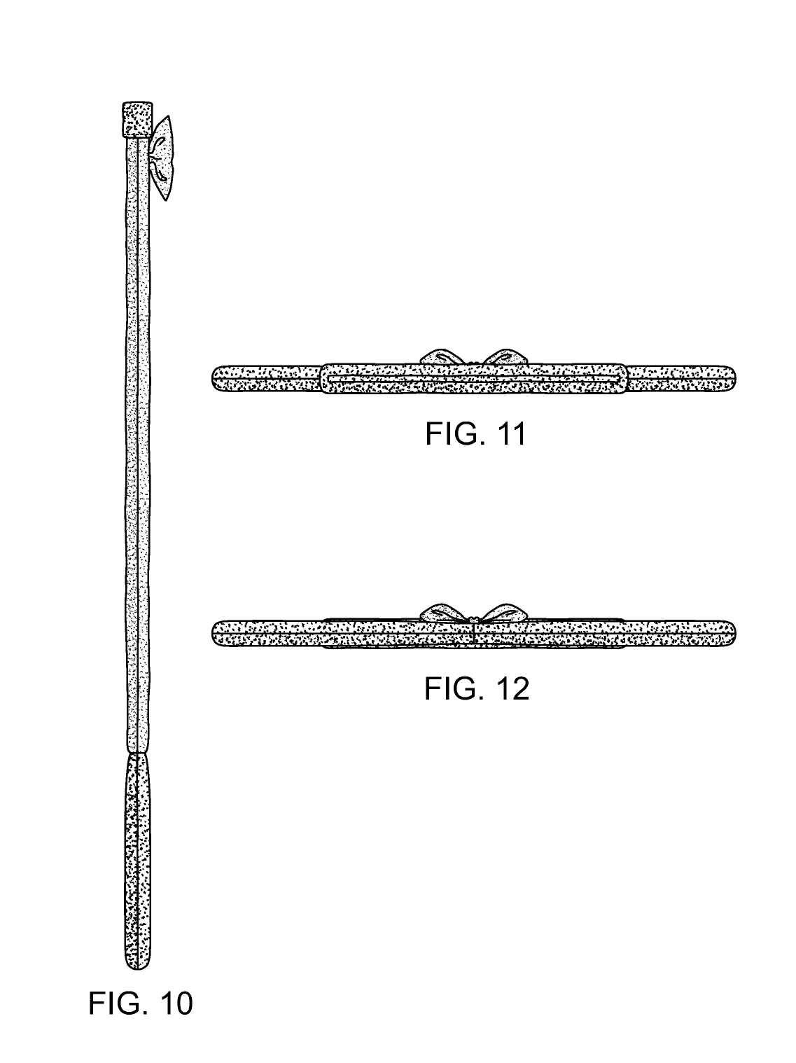

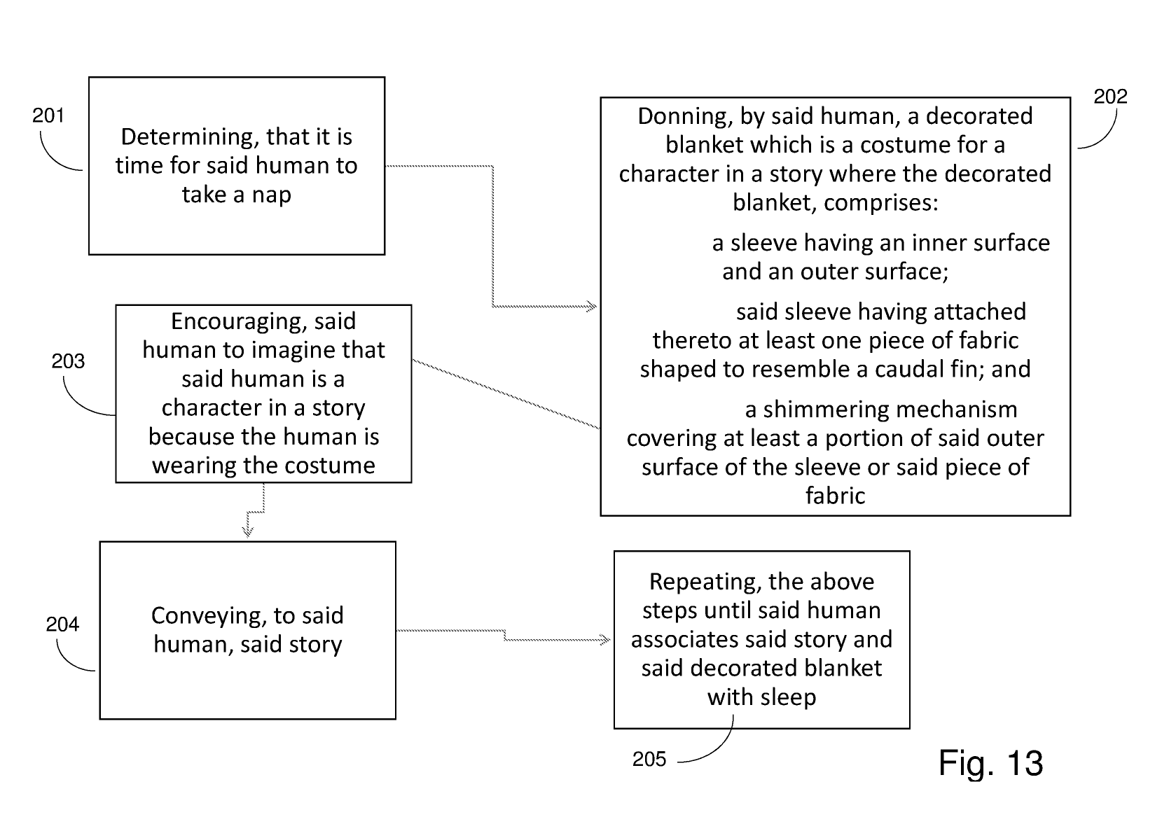

FIGS. 8-12 show alternative views of the embodiment of the present invention depicted in FIG. 7, providing for a full disclosure of the structural components of a preferred embodiment of the decorated blanket of the present invention.

Further, the decorated blanket of the present invention is an effective tool in the process of nap retraining. In the method of the present invention, the decorated blanket of the present invention is employed to condition a human to sleep. In a preferred embodiment of the method of the present invention, the method comprises, step 201 of determining, that it is time for said human to take a nap. This is an important step in the condition of the human, because there must be some sort of trigger that signals in the mind of the human that the sleep process is going to begin. The method then provides for step 202 where this human dons a decorated blanket which is a costume for a character in a story. As previously described, the decorated blanket of the present invention and preferably comprises: a sleeve having an inner surface and an outer surface; said sleeve having attached thereto at least one piece of fabric shaped to resemble a caudal fin; and a shimmering mechanism covering at least a portion of said outer surface of the sleeve or said piece of fabric. In a preferred embodiment, the character in the story is a mermaid. Further, the method then proceeds to step 203, where said human is encouraged to imagine that they are a character in a story, facilitated by the wearing of the decorated blanket of the present invention. If the character of the story has the tail of an aquatic creature, the decorated blanket of the present invention has numerous additional benefits in aiding this step. The method then proceeds to step 204 where the story is conveyed to said human. It is in this time that the sleep inducing effects of “story time” come into play, and hopefully the human user will fall asleep in during the execution of step 204. The last step of the method, step 205, consists of repeating, the above steps until said human associates said story and said decorated blanket with sleep.

This method employs classic conditioning, as made famous by the physiologist Ivan Pavlov. Classic conditioning teaches that, over a period of time, if a subject is given a trigger prior to a specific event, they will behave in a manner expectant of the specific event, regardless of a lack of a logical correlation between the trigger and the specific event. This occurs regardless of whether the specific event actually occurs or not. In a preferred embodiment, the method of the present invention will result in a human mentally preparing for sleep upon the start of the method, regardless of whether the human felt tired before the execution of the method of the present invention. Over time, the repetition of this method will result in a stronger correlation between the trigger and sleep in the human user.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Therefore, it is intended that the disclosure not be limited to the particular embodiments disclosed.

What is claimed is:

1. A decorated blanket, comprising:
a sleeve having an inner surface and an outer surface;
said sleeve having attached thereto at least one piece of fabric shaped to resemble a caudal fin; and
a shimmering mechanism covering at least a portion of said outer surface of the sleeve or said piece of fabric, or some combination thereof.

2. The decorated blanket of claim 1, where said inner surface and said outer surface are constructed out of different materials.

3. The decorated blanket of claim 1, wherein said sleeve is tapered.

4. The decorated blanket of claim 1, wherein said sleeve covers only the legs of a user.

5. The decorated blanket of claim 1, wherein said sleeve covers only the legs and hips of a user.

6. The decorated blanket of claim 1, wherein said sleeve covers only the legs, hips, and midriff of a user.

7. The decorated blanket of claim 1, where said sleeve covers the entirety of a user.

8. The decorated blanket of claim 1, wherein said at least one piece of fabric is shaped to resemble a caudal fin selected from the group consisting of: round caudal fins, forked caudal fins, indented caudal fins, truncate caudal fins, lunate caudal fins, dual-split caudal fins, and pointed caudal fins.

9. The decorated blanket of claim 1, wherein said sleeve is constructed out of jersey knit fabrics.

10. The decorated blanket of claim 1, wherein said sleeve is constructed out of terrycloth.

11. The decorated blanket of claim 1, further comprising a bow affixed to said outer surface.

12. The decorated blanket of claim 1, where the shimmering mechanism comprises a plurality of sequins affixed to said sleeve or said at least one piece of fabric.

13. The decorated blanket of claim 1, wherein said decorated blanket is sized such that said decorated blanket is capable of swaddling a user.

14. The decorated blanket of claim 1, further comprising an expansion mechanism.

15. The decorated blanket of claim 14, wherein said expansion mechanism is selected from the group consisting of: hook and loop fasteners, zippers, buttons, and magnets.

16. The decorated blanket of claim 1, wherein said at least one piece of fabric has at least two layers and is has foam or padding disposed between said layers.

17. The decorated blanket of claim 1, further comprising an elastic band encompassing said opening of said sleeve.

18. The decorated blanket of claim 1, further comprising a drawstring encompassing said opening of said sleeve.

19. A method of conditioning a human to sleep, comprising the steps of:
determining, that it is time for said human to take a nap;
donning, by said human, a decorated blanket which is a costume for a character in a story
where the decorated blanket, comprises:
a sleeve having an inner surface and an outer surface;
said sleeve having attached thereto at least one piece of fabric shaped to resemble a caudal fin; and
a shimmering mechanism covering at least a portion of said outer surface of the sleeve or said piece of fabric;
encouraging, said human to imagine that said human is a character in a story because the human is wearing the costume;
conveying, to said human, said story; and
repeating, the above steps until said human associates said story and said decorated blanket with sleep.

20. The method of claim 19, wherein said decorated blanket is sized such that said decorated blanket is capable of swaddling said human.
